(19) United States
(12) Patent Application Publication
(10) Pub. No.: US 2023/0027451 A1
(43) Pub. Date: Jan. 26, 2023

(54) CONTAINER FOR TIRE VULCANIZER

(71) Applicant: Toyo Tire Corporation, Itami-shi (JP)

(72) Inventor: Masaaki Sakura, Itami-shi (JP)

(73) Assignee: Toyo Tire Corporation, Itami-shi (JP)

(21) Appl. No.: 17/743,657

(22) Filed: May 13, 2022

(30) Foreign Application Priority Data
Jul. 20, 2021 (JP) 2021-119950

(51) Int. Cl. B29D 30/06

(52) U.S. Cl. CPC B29D 30/0629; B29D 2030/063

(57) ABSTRACT

In a container for a tire vulcanizer including a plurality of segments respectively holding sectors arranged in a cylindrical shape, which opens and closes by moving the segments in a radial direction of the cylindrical shape, a protruding member protruding from an opposed surface between the segments adjacent to each other is provided, and a protruding amount of the protruding member from the opposed surface can be adjusted.

### CROSS-REFERENCE TO RELATED APPLICATIONS

This application will enjoy the benefit of priority from this application based on JP-A-2021-119950 (filing date: 20 Jul. 2021). This application incorporates the entire contents of JP-A-2021-119950.

### BACKGROUND OF THE INVENTION

### 1. Field of the Invention

The present invention relates to a container for a tire vulcanizer.

### 2. Description of Related Art

A tire vulcanizer for vulcanizing and molding a pneumatic tire has a structure in which a mold is held inside a device called a container. A plurality of segments are arranged in a cylindrical shape in the container.

Moreover, sectors corresponding to the mold for molding a tread pattern of the pneumatic tire are arranged in a cylindrical shape on an inner diameter side of the cylinder formed by the segments. One sector is held by one segment.

When an unvulcanized tire is inserted to the inside of the mold, the segments and sectors move outward in a radial direction of the cylinder, then, adjacent segments are separated from one another. After the unvulcanized tire is inserted to the inside of the mold in the above state, the segments and the sectors move inward in the radial direction of the cylinder, then, adjacent segments closely contact one another. The sectors and the like are heated in the close contact state, and the unvulcanized tire is vulcanized and molded.

The sectors are thermally expanded at the time of vulcanization molding and the cylinder formed by the plural sectors are increased in diameter, as a result, a gap may be generated between adjacent two segments and a contact pressure between the sectors may be excessive. Accordingly, it has been proposed that shims are arranged between adjacent segments in JP-A-2016-215387 (Patent Literature 1). The gap between adjacent segments may be generated before heating the sectors.

Incidentally, gaps between adjacent segments are not always uniform in a circumferential direction of the cylinder. When shims with the same thickness are provided between all segments nevertheless, pressures generated between adjacent segments vary in the circumferential direction of the cylinder.

For example, when a thinner shim for a gap is provided at a part where the gap between adjacent segments is large, the pressure generated between sectors held by these segments is increased. When a thicker shim for a gap is provided at a part where the gap between adjacent segments is small, sectors held by these segments do not contact each other, or the pressure generated between sectors is reduced.

As a result, there are dangers that the sectors are worn away or deformed at the part where the pressure generated between sectors is large and that failure occurs in the tread pattern at the part where sectors do not closely contact one another.

### SUMMARY OF THE INVENTION

In view of the above, an object of the present invention is to provide a container for a tire vulcanizer capable of making pressures generated between all sectors uniform.

In a container for a tire vulcanizer according to an embodiment including a plurality of segments respectively holding sectors arranged in a cylindrical shape, which opens and closes by moving the segments in a radial direction of the cylindrical shape, a protruding member protruding from an opposed surface between the segments adjacent to each other is provided, in which a protruding amount of the protruding member from the opposed surface can be adjusted.

When the container for the tire vulcanizer according to the embodiment is used, pressures generated between all sectors can be made uniform by adjusting the protruding amount of the protruding members.

### BRIEF DESCRIPTION OF THE DRAWINGS

FIG. 1 is a cross-sectional view of a pneumatic tire;

FIG. 2 is a half cross-sectional view of a tire vulcanizer;

FIG. 3 is a block diagram relating to a controller of the tire vulcanizer;

FIG. 4 is a view of sectors and segments seen from above;

FIG. 5 is a view showing opposed surfaces of the sector and the segment, which is a view seen from a direction of an arrow X in FIG. 4;

FIG. 6 is a cross-sectional view in an upper-lower direction of the segment at a position of stoppers;

FIG. 7 is a view of a place of opposed surfaces between segments seen from above, which is a view obtained when a mold is at room temperature;

FIG. 8 is a view of a place of opposed surfaces between segments seen from above, which is a view obtained when the mold is at a temperature of vulcanization molding;

FIG. 9 is a view of a state where a reference mold is arranged inside the segments, which is seen from above;

FIG. 10 is an enlarged view of a portion of “A” in FIG. 9;

FIG. 11 is an enlarged view of a portion of “B” in FIG. 9;

FIG. 12 is a flowchart of a vulcanization molding process;

FIG. 13 is a view showing a movement of the mold in the vulcanization molding process, which is a view obtained when a green tire is inserted into the mold and held by a bladder;

FIG. 14 is a view showing a movement of the mold in the vulcanization molding process, which is a view obtained when an upper bead ring and a side plate lower to a position at the time of vulcanization molding;

FIG. 15 is a view showing a movement of the mold in the vulcanization molding process, which is a view obtained when the mold is closed; and

FIG. 16 is a view showing a movement of the mold in the vulcanization molding process, which is a view obtained when the bladder is expanded.

### DESCRIPTION OF EMBODIMENTS

First, a structure of a pneumatic tire 1 will be explained.

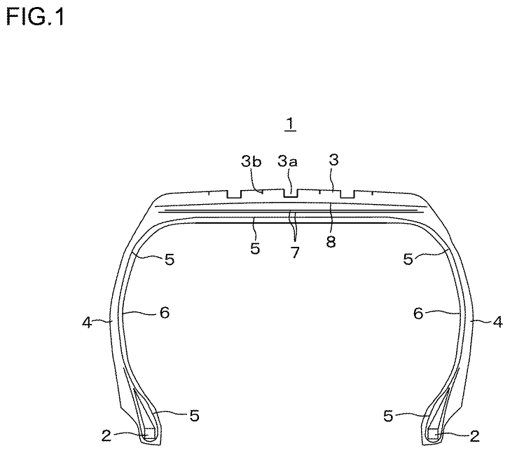

As shown in FIG. 1, bead parts 2 are provided on both sides in a tire axial direction. Each bead part 2 includes a bead core formed of steel wire wound in a circular shape and a rubber bead filler provided on an outer side in a radial direction of the bead core.

A carcass ply 5 is hung across the bead parts 2 on both sides in the tire axial direction. The carcass ply 5 is a sheet-shaped member in which a large number of ply cords aligned in a direction orthogonal to a tire circumferential direction are coated with rubber. The carcass ply 5 forms a frame shape of the pneumatic tire 1 between the bead parts 2 on both sides in the tire axial direction and wraps the bead parts 2 by being turned up from the inside to the outside in the tire axial direction around the bead parts 2.

One or a plurality of belts 7 are provided on an outer side in a tire radial direction of the carcass ply 5. A belt reinforcing layer 8 is provided on an outer side in the tire radial direction of the belts 7. The belt 7 is a member formed of a large number of steel cords coated with robber. The belt reinforcing layer 8 is a member formed of a large number of organic fiber cords coated with rubber.

A tread 3 having a grounding surface is provided on the outer side in the tire radial direction of the belt reinforcing layer 8. In the tread 3, a main groove 3a extending in the tire circumferential direction, grooves such as thin shallow grooves 3b (sipes as a typical example) with narrower and sallower widths than the main groove 3a are formed.

A sheet-shaped inner liner 6 made of rubber with low air permeability is bonded to the inside of the carcass ply 5. Moreover, sidewalls 4 are provided on both sides in the tire axial direction of the carcass ply 5. In addition to these members, members such as a belt-under pad and a chafer are provided according to functional need of the pneumatic tire 1.

Next, the entire structure of the tire vulcanizer 10 will be explained.

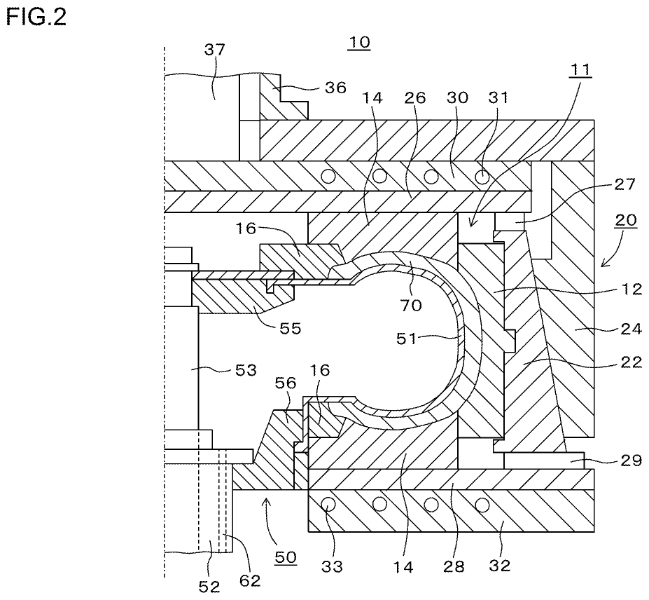

A tire vulcanizer 10 shown in FIG. 2 includes a mold 11 formed of a plurality of molding members. As the plurality of molding members forming the mold 11, a plurality of sectors 12 arranged in a cylindrical shape, an upper and lower pair of side plates 14 arranged on an inner diameter side of the plurality of sectors 12, and an upper and lower pair of bead rings 16 respectively provided on an inner diameter side of the upper and lower side plates 14 are provided.

Surfaces on the inner diameter side of the plurality of sectors 12 have molding surfaces for molding the tread 3 of the pneumatic tire 1. Protrusions such as a main groove protrusion for forming the main groove 3a and protrusions for thin shallow grooves for forming the thin and shallow grooves 3b in the pneumatic tire 1 are formed on the molding surfaces for molding the tread 3. A lower surface of the upper side plate 14 and an upper surface of the lower side plate 14 have molding surfaces for molding the sidewalls 4 of the pneumatic tire 1. A lower surface of the upper bead ring 16 and an upper surface of the lower bead ring 16 have molding surfaces for molding peripheries of the bead parts 2 of the pneumatic tire 1.

The sectors 12 are made of a metal material which can be easily processed. Aluminum or aluminum alloys can be cited as metal materials which can be easily processed and suitable for the sectors 12. The side plates 14 and the bead rings 16 are made of a metal material with high durability. Steel materials can be cited as the metal materials with high durability and suitable for the side plates 14 and the like.

The mold 11 is held by the container 20. The container 20 includes segments 22 provided on an outer diameter side of the sectors 12, a jacket ring 24 provided on an outer diameter side of the segments 22, an upper container plate 26 fixed to an upper surface of the upper side plate 14, and a lower container plate 28 fixed to a lower surface of the lower side plate 14. One segment 22 is provided with respect to one sector 12. The segments 22 are fixed to the sectors 12.

The segments 22, the jacket ring 24, the upper container plate 26 and the lower container plate 28 are made of metal materials with high durability. Steel materials can be cited as metal materials with high durability and suitable for the segments 22 and the like. The segments 22 are made of a metal material with a smaller coefficient of thermal expansion and a higher hardness than the materials for the sector 12.

An upper slide device 27 is provided between the segments 22 and the upper container plate 26. A lower slide device 29 is provided between the segments 22 and the lower container plate 28. When the segments 22 slide with respect to the upper slide device 27 and the lower slide device 29, the segments 22 and the sectors 12 can move in a radial direction of the mold between the upper container plate 26 and the lower container plate 28.

The segments 22 can be separated from the lower container plate 28 and is not capable of being separated from the upper container plate 26. Accordingly, when the upper container plate 26 is lifted, the segments 22 are separated from the lower container plate 28 and lifted integrally with the upper container plate 26. An outer diameter surface of each of the segments 22 is inclined so that an upper side has a small diameter and a lower side has a large diameter.

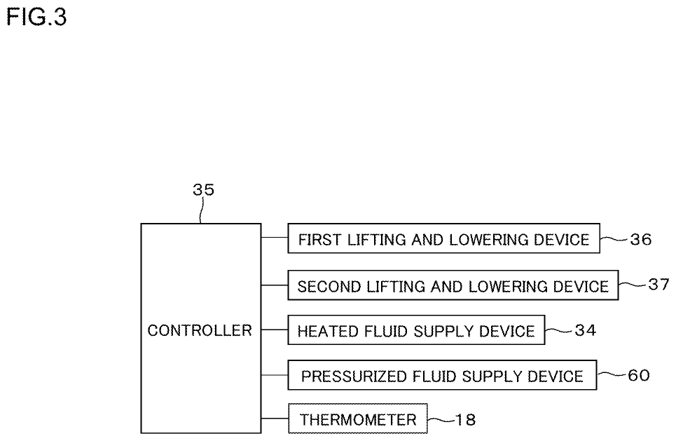

The jacket ring 24 is a cylindrical member, which can be lifted and lowered by a first lifting and lowering device 36 (see FIG. 3) provided above the container 20. An inner diameter surface of the jacket ring 24 is inclined so that an upper side has a small diameter and a lower side has a large diameter.

The inner diameter surface of the jacket ring 24 and the outer diameter surface of the segment 22 have the same inclination angle, which can slide without being separated from each other by a dovetail groove-type guide structure or the like. Due to this structure, when the jacket ring 24 is lowered in a state where the segments 22 are sandwiched between the upper container plate 26 and the lower container plate 28 and are not capable of moving upward and downward, the inner diameter surface of the jacket ring 24 pushes the segments 22 to the inner diameter side, and the segments 22 and the sectors 12 move toward the inner diameter side. Conversely, when the jacket ring 24 is lifted, the segments 22 and the sectors 12 move toward the outer diameter side.

Gaps between adjacent sectors 12 are widened when the sectors 12 move to the outer diameter side, and gaps between adjacent sectors 12 are narrowed when the sectors 12 move toward the inner diameter side.

An upper platen 30 is fixed onto the upper container plate 26 and a lower platen 32 is fixed under the lower container plate 28. The upper platen 30 and the lower platen 32 function as heating devices that heat the mold 11.

A second lifting and lowering device 37 (see FIG. 3) is attached to an upper surface of the upper platen 30. When the second lifting and lowering device 37 is operated, the upper platen 30, the upper container plate 26, the upper side plate 14, the upper bead ring 16, the segments 22, and the sectors 12 are integrally lifted and lowered.

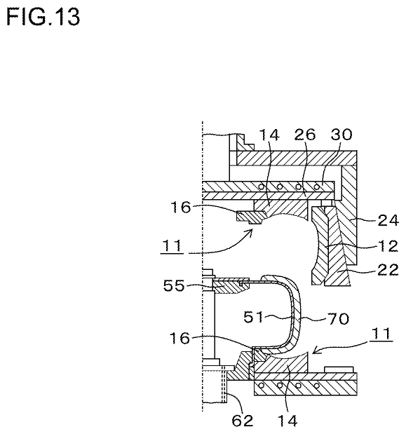

A state where the second lifting and lowering device 37 is operated to lift the upper platen 30 and the like and the first lifting and lowering device 36 is operated to lift the jacket ring 24 and to widen the gaps between the sectors 12 corresponds to a state where the mold 11 is opened (see FIG. 13). On the other hand, a state where the second lifting and lowering device 37 is operated to lower the upper platen 30 and the like to a lowest position in a movable range as shown in FIG. 2 and the first lifting and lowering device 36 is operated to lower the jacket ring 24 and to make adjacent segments 22 closely contact one another corresponds to a state where the mold 11 is closed. At the time of vulcanization molding, respective members are placed at the positions in the mold closed state.

As shown in FIG. 2, a bladder unit 50 including a bladder 51 which can expand and contract is provided on the inner diameter side of the mold 11. The bladder unit 50 is provided with a hollow cylindrical support tube 52 provided on the inner diameter side of the lower container plate 28 and the lower platen 32 and a center shaft 53 inserted into the support tube 52 and upper part thereof protrudes from the support tube 52. A central axis of the support tube 52 and a central axis of the center shaft 53 are coaxial with a central axis of the mold 11. The center shaft 53 can move upward and downward, and an upper clamp 55 fixed above the center shaft 53. A lower clamp 56 is fixed to the support tube 52. When the mold 11 is opened, the center shaft 53 protrudes upward to a higher position and the position of the upper clamp 55 becomes higher than when the mold 11 is closed.

The bladder 51 is formed of a rubber membrane opening upward and downward respectively, having a shape close to the shape of the pneumatic tire 1, in which the bladder 51 opens to the inner diameter side inside the mold 11 in the closed state. The upper clamp 55 holds an upper opening end of the bladder 51 and the lower clamp 56 holds a lower opening end of the bladder 51.

The support tube 52 is provided with a flow path 62 through which heated fluid flows. The heated fluid is supplied from a pressurized fluid supply device 60 (see FIG. 3) provided outside the mold 11. The flow path 62 opens to a place between the upper clamp 55 and the lower clamp 56. Accordingly, the heated fluid supplied from the pressurized fluid supply device 60 flows into the inside of the bladder 51 through the flow path 62 to thereby expand the bladder 51. For example, vapor, hot water or inert gas is used as the fluid supplied from the pressurized fluid supply device 60.

The bladder 51 functions as a pressure device which expands inside a green tire 70 to thereby press the green tire 70 onto an inner surface of the mold 11. The bladder 51 functions also as a heating device which heats the green tire 70 as the bladder 51 becomes high in temperature by the heated fluid. The pressurized fluid supply device 60 also has a function of discharging fluid inside the bladder 51 through the flow path 62.

Moreover, the upper platen 30 and the lower platen 32 function as the heating devices which heat the green tire 70 by heating the mold 11 as described above. Specifically, flow paths 31 are provided inside the upper platen 30 and flow paths 33 are also provided inside the lower platen 32. Heated fluid supplied from a heated fluid supply device 34 (see FIG. 3) flows in the flow paths 31, 33. For example, oil, hot water, or vapor is used as the fluid supplied from the heated fluid supply device 34.

When the heated fluid supplied from the heated fluid supply device 34 flows in the flow paths 31, 33, the upper platen 30 and the lower platen 32 are heated. When the upper platen 30 and the lower platen 32 are heated, the mold 11 is heated by the heat. It is also preferable that another heating means such as an electric heater is provided in the upper platen 30 and the lower platen 32 instead of the flow paths 31, 33.

As shown in FIG. 3, the tire vulcanizer 10 includes a controller 35. The controller 35 is electrically connected to the first lifting and lowering device 36, the second lifting and lowering device 37, the heated fluid supply device 34, the pressurized fluid supply device 60, and the like to control these devices. The controller 35 is also electrically connected to a thermometer 18 that measures the temperature of the mold 11, which can control the heated fluid supply device 34 and the pressurized fluid supply device 60 based on measured results of the thermometer 18.

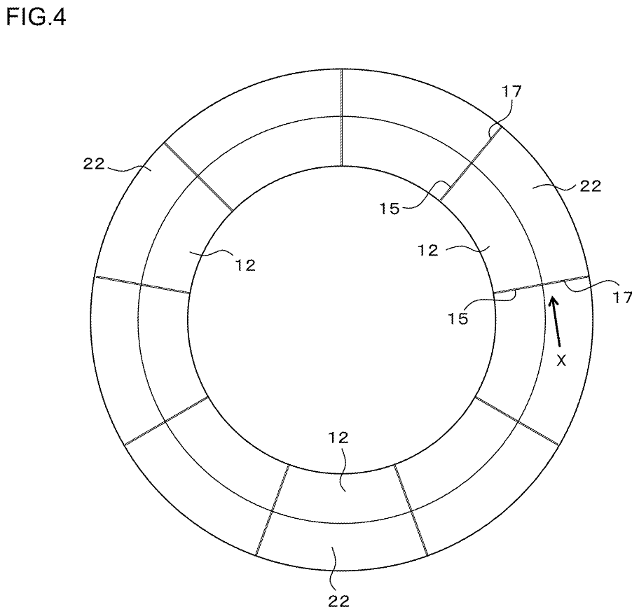

Next, the detailed structure of the segments 22 will be explained with reference to FIG. 4 to FIG. 8.

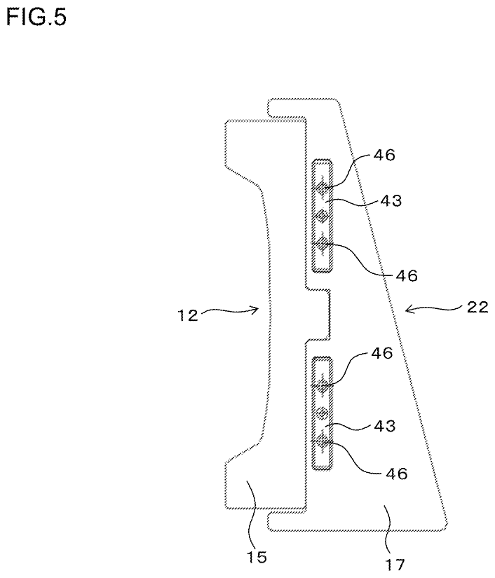

As shown in FIG. 4, the plurality of sectors 12 and the plurality of segments 22 are disposed in a circular shape respectively when seen from above. The sectors 12 are adjacent to one another in the circumferential direction of the mold and the segments 22 are also adjacent to one another in the circumferential direction of the mold. As shown in FIG. 4 and FIG. 5, end faces of each sector 12 on both sides in the circumferential direction of the mold are opposed surfaces 15 with respect to adjacent sectors 12.

End faces of each segment 22 on both sides in the circumferential direction of the mold are opposed surfaces 17 with respect to adjacent segments 22.

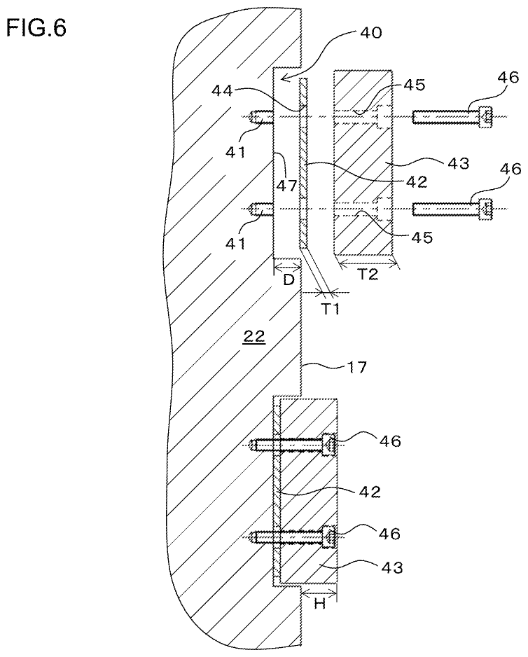

A mounting portion 40 with a shape recessed from the opposed surface 17 is provided at one of the two opposed surfaces 17 included in each segment 22 as shown in FIG. 6. The mounting portion 40 is not provided at the other of the two opposed surfaces 17 included in the segment 22. The mounting portion 40 is a part that forms a rectangular parallelepiped space elongated in an upper-lower direction. A depth D of the mounting portion 40 is, for example, 2 mm or more and 4 mm or less. Bolt holes 41 are formed on a bottom face of the mounting portion 40. Such mounting portions 40 are respectively provided at upper and lower places on the opposed surface 17 (namely, on one side and the other side in the axial direction of the cylinder formed by the plurality of segments 22).

A shim 42 which is a plate, and a stopper 43 which is a protruding member are mounted to the mounting portion 40. The shim 42 is a plate-shaped member having an area slightly smaller than an area of the bottom face of the mounting portion 40 (hereinafter referred to a “mounting surface 47”) when seen from a direction perpendicular to the mounting surface 47. A thickness T1 of the shim 42 is, for example, 0.1 mm or more and 0.5 mm or less. Through holes 44 are provided at places corresponding to the bolt holes 41 in the mounting portion 40. The shim 42 is made of metal such as stainless steel.

The stopper 43 is a rectangular parallelepiped member. The stopper 43 has an area equivalent to the area of the mounting surface 47 when seen from the direction perpendicular to the mounting surface 47 so that the stopper 43 is fitted to the mounting portion 40. A thickness T2 of the stopper 43 is, for example, 12 mm or more and 14 mm or less. Through holes 45 are provided at places corresponding to the bolt holes 41 in the mounting portion 40. The stopper 43 is made of metal with high durability such as steel.

As shown in FIG. 6, the shim 42 is arranged on the mounting surface 47, and the stopper 43 is arranged on the shim 42. That is, the shim 42 is interposed between the mounting surface 47 and the stopper 43. Then, bolts 46 as mounting parts are inserted into the through holes 45 of the stopper 43 and the through holes 44 of the shim 42 and fastened to the bolt holes 41 provided in the mounting surface 47. Counterbores are formed in the through holes 45 of the stopper 43, and heads of the bolts 46 are fitted to the counterbores.

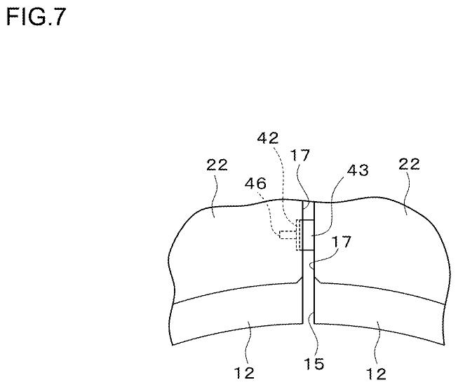

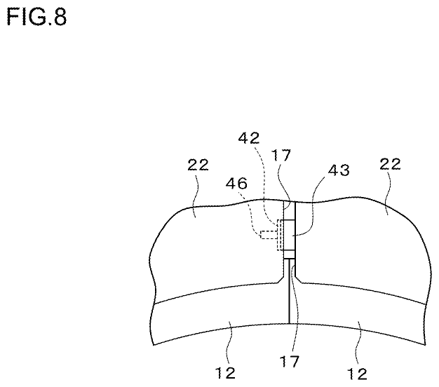

The stopper 43 mounted as described above protrudes from the opposed surface 17 to which the stopper 43 is mounted toward the opposed surface 17 of the adjacent segment 22. A protruding height H (protruding amount) of the stopper 43 is, for example, 8 mm or more and 12 mm or less. The stopper 43 is provided at only one of the two opposed surfaces 17 which are opposed to each other and is not provided at the other of them (see FIG. 7 and FIG. 8).

The mounting portions 40 are respectively provided at upper and lower places on the opposed surface 17 of the segment 22 as described above, and the shims 42 and the stoppers 43 are provided at both upper and lower mounting portions 40. A total value of lengths in an upper-lower direction of two stoppers 43 is preferably 40% or more to 65% or less of a length in the upper-lower direction of the segment 22. Moreover, a total area of the two stoppers 43 (the area when seen from the direction perpendicular to the opposed surface 17) is preferably 5% or more and 20% or less of an area of the opposed surface 17 (the area including places of the two stoppers 43).

It is preferable that the stopper 43 is provided at a place on the inner diameter side than the center of the opposed surface 17 of the segment 22 in the radial direction of the mold. It is also preferable that the stopper 43 is provided at a place including the center of a portion where the segment 22 and the sector 12 are integrated, in the radial direction of the mold.

In all segments 22, upper and lower two shims 42 and stoppers 43 are respectively provided on the opposed surfaces 17 in the same direction in the circumferential direction of the mold as described above. For example, in all segments 22, the shims 42 and the stoppers 43 are provided on the opposed surfaces 17 on the right side when seen from the center of the mold.

All stoppers 43 have the same thickness T2, whereas the thickness T1 of the shims 42 differs according to the place at which the shim 42 is mounted. Therefore, the protruding amount of the stopper 43 from the opposed surface 17 differs according to the place in the circumferential direction of the mold.

When the mold 13 opens, two sectors 12 adjacent to each other are separated and two segments 22 adjacent to each other are also separated. As described in FIG. 7, the stopper 43 provided at one (a left side in FIG. 7) of adjacent two sectors 12 abuts on the opposed surface 17 of the other of the two sectors 12 under room temperature when the mold is closed. However, the two sectors 12 adjacent to each other are separated.

However, when the mold 11 becomes high temperature in the mold closed state for vulcanization molding, the sectors 12 are thermally expanded to be larger than the segments 22, and thus, adjacent two sectors 12 closely contact each other as shown in FIG. 8. Accordingly, a molding surface is formed by the sectors 12 in one circumference of the mold 11.

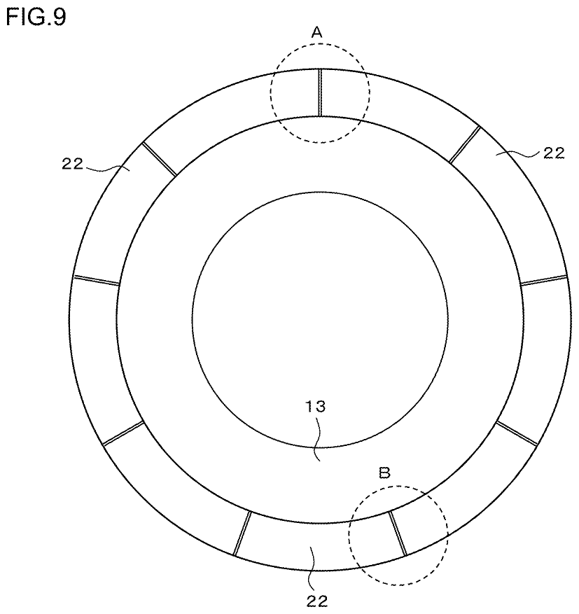

The protruding amount of the stopper 43 from the opposed surface 17 can be adjusted by changing the thickness of the shim 42. An adjusting method will be explained with reference to FIG. 9 to FIG. 11.

First, the stoppers 43 are mounted to the mounting portions 40 of all segments 22 without shims 42 or with the shims 42 having a fixed thickness interposed therebetween. Next, a reference mold 13 is disposed inside the segments 22 arranged in the cylindrical shape as shown in FIG. 9. The reference mold 13 is a mold with a larger outer diameter than that of the mold 11 which is actually used. All segments 22 are already assembled as part of the container 20. Next, all segments 22 are moved to the inner diameter side to a position where the segments 22 abut of an outer diameter surface of the reference mold 13.

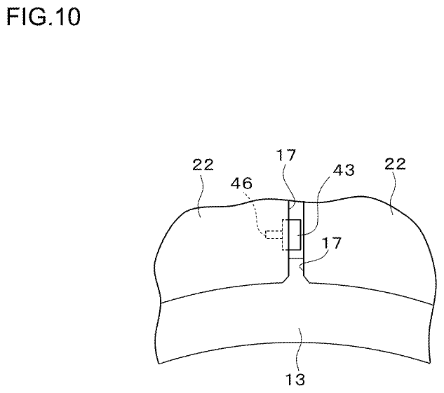

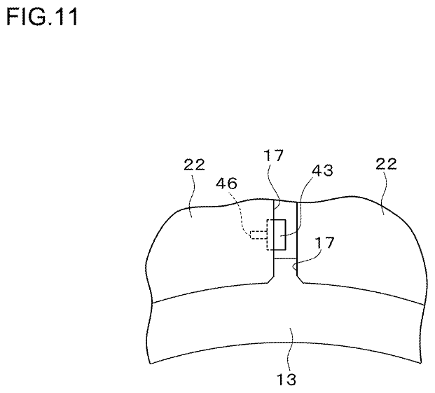

A state at a place “A” in FIG. 9 is shown in FIG. 10 and a state at a place “B” in FIG. 9 is shown in FIG. 11 respectively as the states where all segments 22 abut on the outer diameter surface of the reference mold 13.

Orientations are aligned in FIG. 10 and FIG. 11 to orientations seen from the center of the mold 11 for comparison.

As can be seen from comparison between FIG. 10 and FIG. 11, when all segments 22 abut on the outer diameter surface of the reference mold 13, the gap between the stopper 43 of the segment 22 and the opposed surface 17 of the adjacent segment 22 is narrow at a place (place “A”) and is wide at a place (place “B”). The gap between the stopper 43 and the opposed surface 17 differs at upper and lower two places even in the same segment 22, though not shown.

In view of the above, the thinner shim 42 is interposed between the mounting surface 47 and the stopper 43 at the place where the gap between the stopper 43 and the opposed surface 17 is narrow. The thicker shim 42 is interposed between the mounting surface 47 and the stopper 43 at the place where the gap between the stopper 43 and the opposed surface 17 is wide. Accordingly, the gaps between the stoppers 43 and the opposed surfaces 17 become equal at all places where two segments 22 are adjacent to each other.

As described above, the sectors 12 are attached to the segments 22 in a state where the gaps between the stoppers 43 and the opposed surfaces 17 become equal at all places where two segments 22 are adjacent to each other.

When the mold 11 is closed in the tire vulcanizer 10 in which the sectors 12 are installed, the stoppers 43 and the opposed surfaces 17 closely contact one another at all places where two segments 22 are adjacent to each other. Pressures generated between the stoppers 43 and the opposed surfaces 17 at that time become uniform in the circumferential direction of the mold. When the mold 11 is increased in temperature to a vulcanization temperature, the sectors 12 are thermally expanded to make adjacent sectors 12 closely contact one another. Pressures generated at contact surfaces between the sectors 12 at that time become uniform in the circumferential direction of the mold.

Next, a method of manufacturing the pneumatic tire 1 will be explained.

First, the inner liner 6, the carcass ply 5 and the like are layered on a cylindrical drum to thereby form a cylindrical layered body. Subsequently, the bead parts 2 are set on both sides in the axial direction of the layered body. Then, so-called shaping is executed, in which a portion between the two bead parts 2 in the layered body are expanded in the outer diameter direction. At the same time as the shaping, so-called turning-up is performed, in which portions on both sides in the axial direction of the layered body are turned up around the bead parts 2 to thereby wrap the bead parts 2 with the layered body. A green case is completed in this manner.

On the other hand, the belts 7, the belt reinforcing layer 8, and tread rubber to finally be the tread 3 are layered on the cylindrical drum at another place, thereby forming a cylindrical tread body.

Then, the tread body is bonded to an outer diameter side of the green case, and sidewall rubber to finally be the sidewalls 4 is bonded to both sides in the axial direction of the green case to thereby form a green tire 70.

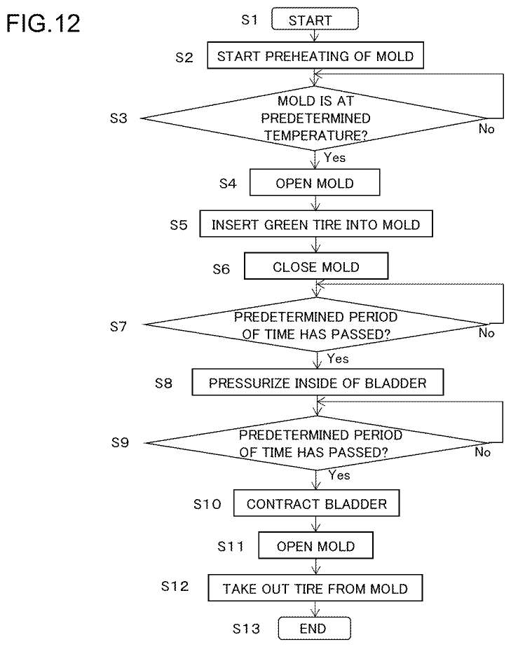

Next, vulcanization molding of the green tire 70 by the tire vulcanizer 10 will be explained with reference to FIG. 12 to FIG. 16.

First, when a vulcanization molding process is started (S1 of FIG. 12), the controller 35 allows heated fluid to flow from the heated fluid supply device 34 to the flow paths 31, 33 to heat the upper platen 30 and the lower platen 32, thereby starting preheating of the mold 11 (S2). As the temperature of the mold 11 is increased, the sectors 12 and the like are thermally expanded and finally become the size at the time of vulcanization molding.

When the mold 11 reaches a predetermined temperature (Yes in S3), an operator or the like operates the first lifting and lowering device 36 and the second lifting and lowering device 37 to open the mold 11 (S4). The controller 35 performs control so that the temperature of the mold 11 is maintained at the predetermined temperature until the vulcanization molding process ends.

After the mold 11 is opened, the green tire 70 is inserted into the mold 11 (S5). When the green tire 70 is inserted into the mold 11, the controller 35 expands the bladder 51 a little so that the green tire 70 is held by the bladder (FIG. 13).

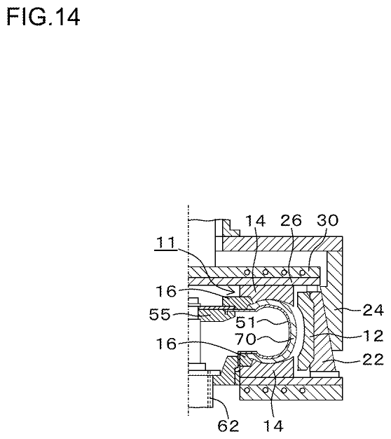

Next, the controller 35 performs an operation of closing the mold 11 by operating the first lifting and lowering device 36 and the second lifting and lowering device 37. First, the controller 35 operates the first lifting and lowering device 36 and the second lifting and lowering device 37 to lower the upper platen 30, the upper container plate 26, the upper side plate 14, the upper bead ring 16, the jacket ring 24, the segments 22, and the sectors 12 (FIG. 14). The upper bead ring 16 abuts on the upper bead part of the green tire 70 during the lowering. After the upper bead ring 16 abuts thereon, the upper bead ring 16, the upper bead part of the green tire 70, and the upper clamp 55 integrally lower to the position at the time of vulcanization molding.

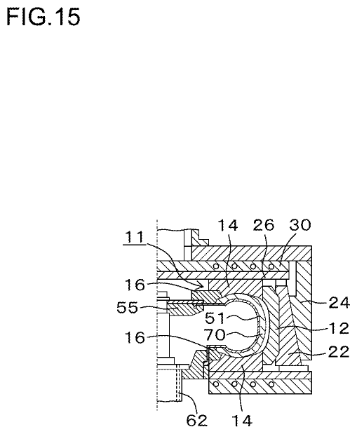

After the upper platen 30, the upper container plate 26, the upper side plate 14, and the upper bead ring 16 lower to the position at the time of vulcanization molding (FIG. 14), the controller 35 subsequently operates the first lifting and lowering device 36 to lower the jacket ring 24, thereby moving the sectors 12 to the position at the time of vulcanization molding (FIG. 15). The mold 11 is closed when movement of respective members to the position at the time of vulcanization molding is completed as described above (S6).

The controller 35 starts preheating of the green tire 70 after closing the mold 11. The preheating is performed by the controller 35 holding the green tire 70 inside the mold 11 without starting to pressurize the inside of the bladder 51 after the mold 11 is closed. During the preheating, that is, in a period from the closing of the mold 11 until starting to pressurize the inside of the bladder 51 as described later, at least part of the tread rubber of the green tire 70 is separated from the inner surface of the mold 11. The preheating of the green tire 70 is performed for a predetermined period of time from the closing of the mold 11.

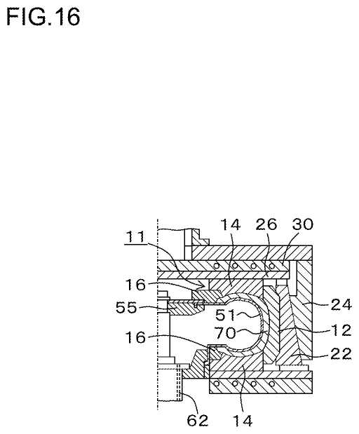

When the predetermined period of time of the preheating has passed (Yes in S7), the controller 35 completes the preheating of the green tire 70 and starts to pressurize the inside of the bladder 51 (58). The pressurization is performed by the controller 35 supplying fluid from the pressurized fluid supply device 60 to the inside of the bladder 51. The bladder 51 is further expanded by the pressurization. As a result, the entire outer surface including the surface of the tread rubber of the green tire 70 are pressed onto the inner surface of the mold 11 due to the bladder 51 to pressurize the green tire 70 (FIG. 16). As the fluid supplied to the inside of the bladder 51 has a high temperature, the green tire 70 is heated not only from the mold 11 side but also from the bladder 51 side. The green tire 70 is pressurized and heated as described above to thereby perform vulcanization molding.

The vulcanization molding begins when the above preheating is completed and the pressurization to the inside of the bladder 51 is started, and ends when the bladder 51 is completely contracted after the pressurization and heating are performed continuously for a predetermined period of time as described later.

When the predetermined period of time of vulcanization molding has passed (Yes in S9), the controller 35 makes the fluid start to discharge from the inside of the bladder 51 and makes the bladder 51 start to contract (910). The controller 35 operates the first lifting and lowering device 36 and the second lifting and lowering device 37 to open the mold 11 after the bladder 51 is completely contracted (S11). Then, the pneumatic tire 1 is taken out from the opened mold 11 (S12), and the vulcanization molding process ends (S13).

After that, finishing such as removal of protrusions of unnecessary rubber produced on the surface of the pneumatic tire 1 is performed. The pneumatic tire 1 is completed in this manner.

When the vulcanization molding process ends, the mold 11 has the predetermined temperature by the preheating.

Accordingly, when vulcanization molding is successively performed to a plurality of green tires, the preheating of the mold 11 may be omitted in vulcanization molding after the second time.

Next, advantages of the embodiment will be explained.

The container 20 according to the embodiment is provided with the stopper 43 as a protruding member protruding from the opposed surface 17 of the segment 22 as described above. Then, the stopper 43 of one segment 22 of adjacent two segments 22 abuts on the opposed surface 17 of the other segment 22 when the mold 11 is closed. It is possible to prevent adjacent sectors 12 from strongly collide with each other, which can prevent abrasion and deformation of the sector 12.

Here, the sectors 12 are made of a metal material easily processed and tend to be worn away or deformed such as aluminum. The sectors 12 do not strongly collide with one another as described above; therefore, abrasion and deformation of the sectors 12 can be prevented. On the other hand, the segments 22 and the stoppers 43 are made of metal materials with high durability such as steel; therefore, the segments 22 and the stoppers 43 are not easily worn away and deformed even when the stopper 43 of one segment 22 abuts on the opposed surface 17 of the other segment 22.

Furthermore, the protruding amount of the stopper 43 from the opposed surface 17 can be adjusted in the container 20 according to the embodiment. Accordingly, it is possible to adjust an abutting state between adjacent segments 22 when the mold 11 is closed, which can make pressures generated between adjacent sectors 12 uniform in the circumferential direction of the mold.

When the pressures generated between adjacent sectors 12 are uniform in the circumferential direction of the mold as described above, it is possible to prevent a high pressure from being applied frequently to a particular sector 12 and to prevent the sector 12 from being worn away or deformed.

Here, the shim 42 which is a plate is interposed between the mounting surface 47 of the segment 22 and the stopper 43. The protruding amount of the stopper 43 from the opposed surface 17 of the segment 22 can be easily changed by changing the thickness of the shim 42. The stopper 43 is made of a material with a high hardness such as steel for withstanding a use state in which the stopper 43 abuts on the opposed surface 17 of the segment 22 many times; therefore, it is not easy to prepare a large number of stoppers 43 with different thicknesses processed with high accuracy, whereas, it is easy to prepare a large number of shims 42 with different thicknesses.

Moreover, the stoppers 43 are respectively provided at upper and lower two places corresponding to one side and the other side in the axial direction of the cylinder formed by the segments 22, and the protruding amount of the stoppers 43 can be adjusted respectively at the upper and lower places. Accordingly, the pressures generated between adjacent sectors 12 can be made uniform at upper and lower places.

For example, there is a case where the gap between two segments 22 adjacent to each other differs at the upper and lower places of the segments 22 when deformation such as distortion occurs in the segment 22. Even in such case, pressures generated between adjacent two sectors 12 can be made uniform at the upper and lower places of the sectors 12 by adjusting the protruding amounts of the stoppers 43 at upper and lower places respectively.

The stopper 43 can be mounted to and removed from the mounting portion 40 of the segment 22 by the bolts 46 as the mounting parts. Accordingly, replacement of shims 42 can be easily performed.

The stopper 43 is provided at a place on the inner diameter side than the center of the opposed surface 17 of the segment 22 in the radial direction of the mold; therefore, it is possible to prevent the sectors 12 from abutting on each other before the segments 22 abut on each other when the segments 22 holding the sectors 12 move to a direction of closing the mold 11. Moreover, the stopper 43 is provided at the place including the center portion of the portion where the segment 22 and the sector 12 are integrated, in the radial direction of the mold; therefore, the pressure from the opposed segment 22 and the sector 12 can be received by the center portion where the stopper 43 exists when the mold 11 is closed.

When the total value of lengths in the upper-lower direction of two stoppers 43 is 40% or more of the length in the upper-lower direction of the segment 22, the force from the opposed segment 22 can be positively received by the two stoppers 43. When the total value of lengths in the upper-lower direction of two stoppers 43 is 65% or less of the length in the upper-lower direction of the segment 22, it is unlikely that a portion to be strongly pressed (namely, a portion receiving a large pressure) and a portion to be softly pressed (namely, a portion receiving a small pressure) are generated in the stoppers 43.

When the total area of the two stoppers 43 is 5% or more of the area of the opposed surface 17, the force from the opposed segment 22 can be positively received by the two stoppers 43. When the total area of the two stoppers 43 is 20% or less of the area of the opposed surface 17, it is unlikely that a portion to be strongly pressed and a portion to be softly pressed are generated in the stoppers 43.

The above embodiment is cited as an example and the scope of the invention is not limited to this. Various modifications, replacements, omissions, and so on may occur in the above embodiment in a scope not departing from the gist of the invention.

For example, only one stopper 43 may be provided with respect to one opposed surface 17. In that case, it is preferable that the stopper 43 is provided as a place including the center in the upper-lower direction of the opposed surface 17. Moreover, three of more stoppers 43 may be provided with respect to one opposed surface 17.

### REFERENCE SIGNS LIST

1: pneumatic tire
2: bead part
3: tread
3a: main groove
3b: shallow groove
4: sidewall
5: carcass ply
6: inner liner
7: belt
8: belt reinforcing layer
10: tire vulcanizer
11: mold
12: sector
13: reference mold
14: side plate
15: opposed surface
16: bead ring
17: opposed surface
18: thermometer
20: container
22: segment
24: jacket ring
26: upper container plate
27: upper slide device
28: lower container plate
29: lower slide device
30: upper platen
31: flow path
32: lower platen
33: flow path
34: heated fluid supply device
35: controller
36: first lifting and lowering device
37: second lifting and lowering device
40: mounting portion
41: bolt hole
42: shim
43: stopper
44: through hole
45: through hole
46: bolt
47: mounting surface
50: bladder unit
51: bladder
52: support tube
53 center shaft
55: upper clamp
56: lower clamp
60: pressurized fluid supply device
62: flow path
70: green tire

What is claimed is:

1. A container for a tire vulcanizer provided with a plurality of segments respectively holding sectors arranged in a cylindrical shape, which opens and closes by moving the segments in a radial direction of the cylindrical shape, the container comprising:
a protruding member protruding from an opposed surface between the segments adjacent to each other,
wherein a protruding amount of the protruding member from the opposed surface can be adjusted.

2. The container for the tire vulcanizer according to claim 1,
wherein a mounting portion to which the protruding member is mounted is provided on the opposed surface, and
a plate is interposed between a mounting surface included in the mounting portion and the protruding member.

3. The container for the tire vulcanizer according to claim 1,
wherein the protruding members are respectively provided on one side and the other side in an axial direction of the cylindrical shape formed by the plurality of segments.

4. The container for the tire vulcanizer according to claim 1,
wherein the protruding member can be mounted to and removed from the segment.
